(19) United States
(12) Patent Application Publication
(10) Pub. No.: US 2008/0081870 A1
(43) Pub. Date: Apr. 3, 2008

(54) Size composition

(76) Inventors: Thorsten Rische, Unna (DE); Thomas Munzmay, Dormagen (DE); Harald Blum, Leverkusen (DE); Thomas Feller, Solingen (DE)

Correspondence Address: BAYER MATERIAL SCIENCE LLC, 100 BAYER ROAD, PITTSBURGH, PA, 15205, US

(21) Appl. No.: 11/904,258

(22) Filed: Sep. 26, 2007

(30) Foreign Application Priority Data
Sep. 29, 2006 (DE) 102006046649.7

(51) Int. Cl. C08G 18/32

(52) U.S. Cl. 524/591; 524/590

(57) ABSTRACT

The invention relates to polyurethane-polyurea dispersions comprising structural units of formula (I) 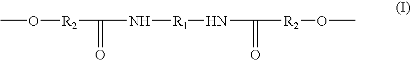
in which R₁ is an aliphatic or cycloaliphatic radical having 2 to 18 C atoms and R₂ is an aliphatic radical having 3 to 5 C atoms. Preparation of the polyurethane-polyurea dispersion and use as a size composition is also disclosed.

### CROSS REFERENCE TO RELATED APPLICATION

This application claims priority under 35 U.S.C. § 119 (a-d) to German application DE 10 2006 046 649.7, filed Sep. 29, 2006.

### FIELD OF THE INVENTION

The invention relates to polyurethane-polyurea dispersions with amide structural units and also to their preparation and use as a sizing composition.

### BACKGROUND OF THE INVENTION

Glass fibres and carbon fibres are sized using, as described for example in EP-A 792 900, polyurethane-polyurea dispersions (PUR dispersions) and crosslinkers as binder components in the size composition.

Glass fibre-reinforced polyamides combine high stiffness and strength with an extreme impact strength and are therefore robust in the face of mechanical stress. The coating of such glass fibre-reinforced polyamides, however, generally causes problems, since the surface is heterogeneous and therefore pores and cracks are formed. Furthermore, there may be instances of disruption to adhesion. The size compositions described to date in the prior art that are suitable for the production of glass fibres or carbon fibres are inadequate at improving the reinforcing properties of the fibres incorporated into polyamide.

### SUMMARY OF THE INVENTION

It was an object of the present invention, therefore, to provide glass fibre sizes which improve the impact strength of the glass fibre-reinforced polyamides 6 and polyamides 6,6 and which overcome the disadvantages of the prior art.

It has now been found that glass fibres coated with aqueous sizes comprising not only PUR polymers based on specific, at least dihydroxy-functional polyamide polyols having at least 2 amide groups but also blocked polyisocyanate crosslinkers optionally containing hydrophilic groups and/or dispersible in water and/or dispersed in water display excellent reinforcing properties in the polymer compound, in particular in polyamide 6 and polyamide 6,6.

EP-A 0 595 281 describes water-dispersible, polyamide-modified polyurethanes for producing automotive paints, comprising among other components a polyamide macromonomer prepared from acid anhydrides and/or acid halides and diamines and/or amino alcohols. A disadvantageous feature of these systems is that the preparation of the polyamide macromonomers is very complicated and the water solubility of the resulting polyamide macromonomers is still very poor. There is no description of these compounds being suitable for producing glass fibre sizes.

U.S. Pat. No. 6,455,632 describes aqueous polyurethane dispersions with secondary amide groups. They are prepared by reacting, for example, isocyanates with specific hydroxy-functional monoamides. The resulting polymer then enters into crosslinking reactions with melamine-formaldehyde resins, urea resins, N-methylolacrylamide emulsions or isobutoxymethylacrylamide emulsions. The dispersions are suitable for heat-curable coating materials, coatings, and sealants. Amide compounds containing two or more amide structural units are not described, and nor is the particular suitability of the amide-functional polyurethane dispersions as glass fibre sizes.

The present invention accordingly provides aqueous polyurethane-polyurea polymer dispersions (PUR polymers) containing structural units of formula (I) 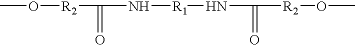
in which

R₁ is an aliphatic or cycloaliphatic radical having 2 to 18 C atoms and

R₂ is an aliphatic radical having 3 to 5 C atoms.

The backbone of the polyurethane contains at least 0.5%, preferably 0.75% to 10%, more preferably 0.9% to 5.0% by weight of amide groups (calculated as (CO)NH).

Likewise provided by the present invention are size compositions comprising the aqueous PUR polymer dispersions (I) of the invention and
(II) hydrophilicized, blocked polyisocyanates, at least 50% of whose isocyanate groups are blocked,
(III) optionally further polymers soluble, emulsifiable or dispersible in water, and
(IV) auxiliaries and additives selected from the group of coupling agents, lubricants, antistats, dyes, pigments, flow control agents, light stabilizers, ageing inhibitors or UV absorbers.

The polyurethane-polyurea polymers (PUR polymers) of the dispersions of the invention comprise the reaction products of:
I.1) one or more polyisocyanates,
I.2a) one or more polymeric polyols having number-average molecular weights of 200 to 8000 g/mol,
I.2b) one or more polyamide polyols of the general formula (II) 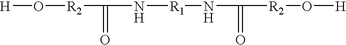
   in which

R₁ is an aliphatic or cycloaliphatic radical having 2 to 18 C atoms and

R₂ is an aliphatic radical having 3 to 5 C atoms,
I.3) one or more low molecular weight compounds of molar weight 62 to 400, possessing in total two or more hydroxyl and/or amino groups,
I.4) optionally, one or more compounds which possess a hydroxyl or amino group, and one or more compound(s) selected from the group consisting of
I.5) isocyanate-reactive, ionically or potentially ionically hydrophilicizing compounds and/or
I.6) isocyanate-reactive, nonionic hydrophilicizing compounds.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

Suitable polyisocyanates of component I.1) are the aromatic, araliphatic, aliphatic or cycloaliphatic polyisocyanates that are known per to a person skilled in the art. Examples of suitable polyisocyanates are 1,4-butylene diisocyanate, 1,6-hexa-methylene diisocyanate (HDI), isophorone diisocyanate (IBDI), 2,2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-tolylene diisocyanate, 1,5-naphthylene diisocyanate, 2,4′- or 4,4′-diphenylmethane diisocyanate, 1,3- and 1,4-bis(2-isocyanatoprop-2-yl)benzene (TMXDI), 1,3-bis(isocyanatomethyl)benzene (XDI), (S)-alkyl-2,6-diisocyanatohexanoates or (L)-alkyl-2,6-diisocyanatohexanoates.

Proportionally it is also possible to use polyisocyanates having a functionality ≧2. These include modified diisocyanates having a uretdione, isocyanurate, urethane, allophanate, biuret, iminooxadiazinedione and/or oxadiazinetrione structure, and also unmodified polyisocyanates having more than 2 NCO groups per molecule, e.g. 4-isocyanatomethyl 1,8-octane diisocyanate (nonane triisocyanate) or triphenylmethane 4,4′,4″-triisocyanate.

The polyisocyanates or polyisocyanate mixtures in question are preferably those of the aforementioned kind containing exclusively aliphatically and/or cycloaliphatically attached isocyanate groups, with an average functionality of 2 to 4, preferably 2 to 2.6 and more preferably 2 to 2.4.

Particular preference is given to hexamethylene diisocyanate, isophorone diisocyanate, the isomer of bis(4,4′-isocyanatocyclohexyl)methane and also mixtures thereof.

Polymeric polyols which can be used as compounds I.2a) have a molecular weight Mn of 400 to 8000 g/mol, preferably of 400 to 6000 g/mol and more preferably of 600 to 3000 g/mol. Their hydroxyl number is 22 to 400 mg KOH/g, preferably 30 to 200 mg KOH/g and more preferably 40 to 160 mg KOH/g, and they have an OH functionality of 1.5 to 6, preferably of 1.8 to 3, and more preferably of 1.9 to 2.1.

Polyols for the purposes of the present invention are the organic polyhydroxyl compounds known in polyurethane coating technology, such as, for example, the typical polyester polyols, polyacrylate polyols, polyurethane polyols, polycarbonate polyols, polyether polyols, polyester-polyacrylate polyols and also polyurethane-polyacrylate polyols, polyurethane-polyester polyols, polyurethane-polyether polyols, polyurethane-polycarbonate polyols, polyester-polycarbonate polyols, phenol/formaldehyde resins, alone or in mixtures. Polyester polyols are preferred.

Highly suitable examples of polyester polyols are the on are the known polycondensates of diols and also, optionally, triols and tetraols and dicarboxylic and also, optionally, tricarboxylic and tetracarboxylic acids or hydroxycarboxylic acids or lactones. In place of the free polycarboxylic acids it is also possible to use the corresponding polycarboxylic anhydrides or corresponding polycarboxylic esters of lower alcohols to prepare the polyesters. Examples of suitable diols are ethylene glycol, butylene glycol, diethylene glycol, triethylene glycol, polyalkylene glycols such as polyethylene glycol, also 1,2-propanediol, 1,3-propanediol, butane-1,3-diol, butane-1,4-diol, hexane-1,6-diol and isomers, neopentyl glycol or hydroxypivalic acid neopenthyl glycol ester, the three last-mentioned compounds being preferred. Polyols for optional additional use here are for example trimethylolpropane, glycerol, erythritol, pentaerythritol, triemthylolbenzene or trishydroxyethyl isocyanurate.

Suitable dicarboxylic acids include, for example, phthalic acid, isophthalic acid, terephthalic acid, tetrahydrophthalic acid, hexahydrophthalic acid, cyclohexane-dicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid, 2,2-dimethylsuccinic acid. Anhydrides of these acids are likewise possible for use, where they exist. For the purposes of the present invention, therefore, the anhydrides are embraced by the expression “acid”. It is also possible to use monocarboxylic acids, such as benzoic acid and hexanecarboxylic acid, subject to the proviso that the average functionality of the polyol is ≧2. Saturated aliphatic or aromatic acids are preferred, such as adipic acid or isophthalic acid. As a polycarboxylic acid for use as well where appropriate, in relatively small amounts, mention may be made here of trimellitic acid.

Hydroxycarboxylic acids which can as well be used as reaction participants in the preparation of a polyester polyol having terminal hydroxyl groups are, for example, hydroxycaproic acid, hydroxybutyric acid, hydroxydecanoic acid, hydroxystearic acid and the like. Lactones that can be used include caprolactone, butyrolactone and homologues.

Suitable polyamide polyols I.2b) of formula (II) are obtained by reacting at least difunctional amines, such as ethylenediamine, 1,2-propanediamine, 1,3-propane-diamine, 1,4-butanediamine, 1,3-butanediamine, 1,2-butanediamine, pentanediamine, 1,6-hexanediamine, 1,8-octanediamine, C9 to C10 diamines, C13 to C27 diamines, 1,4-cyclohexylmethyldiamine, amino-3,3,5-trimethyl-5-aminomethylcyclohexane (isophoronediamine), 1,4-diaminocyclohexane, bis(4-aminocyclohexyl)methane, diethylenetriamine, nonanetriamine, 2,5-diamino-2,5-dimethylhexane, 1,5-diamino-2-methylpentane (Dytek® A, DuPont), 2,2,4- and/or 2,4,4-trimethyl-1,6-diaminohexane, 1,11-diaminoundecane, 1,12-diaminododecane, Laromin® C260 (4,4′-diamino-3,3′-dimethylcyclohexylmethane, BASF AG, DE), tricyclodecanediamine (TCD diamine), 4,4′-methylenebis(2,6-diethylcyclohexanamine), higher molecular weight polyether polyamines with aliphatically attached, primary amino groups, of the kind sold for example by Huntsman under the name Jeffamin®, with ε-caprolactone. Likewise suitable are difunctional amines which additionally contain other functional groups, hydroxyl groups for example, such as N-hydroxyethylethylenediamine, N-hydroxypropylethylenediamine, N-hydroxyethylpropanediamine, N-hydroxyethylbutanediamine or N-hydroxyethylhexanediamine.

Likewise suitable are mixtures of the said at least difunctional amines which if desired contain further functional groups, including for example mixtures with further difunctional amines. In minor amounts it is also possible to use monofunctional amines as well. The proportion of at least difunctional amines must in that case be at least 70%, though.

Component I.2b) is synthesized preferably from diamines containing a primary and a secondary amino group, and ε-caprolactone.

With particular preference the PUR dispersions of the invention comprise reaction products of compounds selected from the group of 1,6-hexamethylenediamine, 2-methyl-1,5-diaminopentane, 1-amino-3,3,5-trimethyl-5-aminomethylcyclohexane (isophoronediamine), the isomers of bis(4-aminocyclohexyl)methane, and mixtures thereof, with ε-caprolactone.

To prepare the amide polyols, one equivalent of amino groups is reacted with 0.9 to 2.0, preferably with 1.0 to 1.3, equivalents of ε-caprolactone. This reaction may be carried out at room temperature to 200° C., where appropriate with assistance of catalytic substances, examples being tin compounds, tertiary amino compounds, titanium tetrabutoxide, trialkylphosphine compounds, hexamethylenedisilazane, benzyltrimethylammonium hydroxide, acidic compounds such as para-toluene-sulphonic acid, for example. Preference is given to using tin catalysts, and with particular preference the preparation takes place without catalyst.

The low molecular weight polyols I.3) used for synthesizing the polyurethane resins generally have the effect of stiffening and/or branching the polymer chain. The molecular weight is situated preferably between 62 and 200. Suitable polyols may contain aliphatic, alicyclic or aromatic groups. Mention may be made here, by way of example, of the low molecular weight polyols having up to about 20 carbon atoms per molecule, such as ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, hydroquinone dihydroxyethyl ether, bisphenol A (2,2-bis(4-hydroxyphenyl)propane), hydrogenated bisphenol A (2,2-bis(4-hydroxycyclohexyl)propane), and mixtures thereof, and also trimethylolpropane, glycerol or pentaerythritol. Ester diols as well, such as δ-hydroxybutyl-ε-hydroxycaproic ester, ω-hydroxyhexyl-γ-hydroxybutyric ester, adipic acid (β-hydroxyethyl) ester or terephthalic acid bis(β-hydroxyethyl)ester, can be used.

Diamines or polyamines and also hydrazides may likewise be employed as component I.3), examples being ethylenediamine, 1,2- and 1,3-diaminopropane, 1,4-diaminobutane, 1,6-diaminohexane, isophoronediamine, isomer mixture of 2,2,4- and 2,4,4-trimethylhexamethylenediamine, 2-methylpentamethylenediamine, diethylenetriamine, 1,3- and 1,4-xylylenediamine, α, α, α′, α′-tetramethyl-1,3- and 1,4-xylylenediamine and 4,4-diaminodicyclohexylmethane, dimethylethylenediamine, hydrazine or adipic dihydrazide.

Also suitable in principle as I.3) are compounds which contain active hydrogen with different reactivity towards NCO groups, such as compounds which in addition to a primary amino group also contain secondary amino groups, or in addition to an amino group (primary or secondary) also contain OH groups. Examples of such are primary/secondary amines, such as 3-amino-1-methylaminopropane, 3-amino-1-ethylaminopropane, 3-amino-1-cyclohexylaminopropane, 3-amino-1-methylaminobutane, additionally alkanolamines such as N-aminoethylethanolamine, ethanolamine, 3-aminopropanol or neopentanolamine. Preference is given to diethanolamine.

The polyurethane resin may also optionally include units I.4) which are located in each case at the chain ends and cap them. These units derive on the one hand from monofunctional compounds that are reactive with NCO groups, such as monoamines, especially mono-secondary amines, or monoalcohols. Examples that may be mentioned here include the following: ethanol, n-butanol, ethylene glycol monobutyl ether, 2-ethylhexanol, 1-octanol, 1-dodecanol, 1-hexadecanol, methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, and/or suitable substituted derivatives thereof, amide amines of diprimary amines and monocarboxylic acids, monoketimes of diprimary amines, primary/tertiary amines, such as N,N-dimethylaminopropylamine and the like.

By ionically and potentially ionically hydrophilicizing compounds I.5) are meant all compounds which contain at least one isocyanate-reactive group and also at least one functionality, such as —COOY, —SO₃Y, —PO(OY)₂ (Y for example ═H, NH₄⁺, metal cation), —NR₂, —NR₃⁺ (R═H, alkyl, aryl), which on interaction with aqueous media enters into a pH-dependent dissociation equilibrium and in that way can have a negative, positive or neutral charge. Preferred isocyanate-reactive groups are hydroxyl or amino groups.

Suitable ionically or potentially ionically hydrophilicizing compounds meeting the definition of component I.5) are, for example, mono- and dihydroxycarboxylic acids, mono- and diaminocarboxylic acids, mono- and dihydroxysulphonic acids, mono- and diaminosulphonic acids and also mono- and dihydroxyphosphonic acids or mono- and diaminophosphonic acids and salts thereof such as dimethylolpropionic acid, dimethylolbutyric acid, hydroxypivalic acid, N-(2-aminoethyl)-β-alanine, 2-(2-aminoethylamino)ethanesulphonic acid, ethylenediaminepropyl- or -butylsulphonic acid, 1,2- or 1,3-propylenediamine-β-ethylsulphonic acid, malic acid, citric acid, glycolic acid, lactic acid, glycine, alanine, taurine, lysine, 3,5-diaminobenzoic acid, an adduct of IPDI and acrylic acid (EP-A 0 916 647, Example 1) and the alkali metal and/or ammonium salts thereof; the adduct of sodium bisulphite with but-2-ene-1,4-diol, polyethersulphonate, the propoxylated adduct of 2-butenediol and NaHSO₃, described for example in DE-A 2 446 440 (page 5-9, formula I-III), and compounds which contain units which can be converted into cationic groups, amine-based units for example, such as N-methyldiethanolamine, as hydrophilic synthesis components. Additionally it is possible to use cyclohexylaminopropanesulphonic acid (CAPS) such as in WO-A 01/88006, for example, as a compound meeting the definition of component I.5).

Preferred ionic or potential ionic compounds I.5) are those which possess carboxyl or carboxylate and/or sulphonate groups and/or ammonium groups. Particularly preferred ionic compounds I.5) are those containing carboxyl and/or sulphonate groups as ionic or potentially ionic groups, such as the salts of N-(2-aminoethyl)-β-alanine, of 2-(2-aminoethylamino)ethanesulphonic acid or of the adduct of IPDI and acrylic acid (EP-A 0 916 647, Example 1) and also of dimethylolpropionic acid.

Suitable nonionically hydrophilicizing compounds meeting the definition of component I.6) are, for example, polyoxyalkylene ethers containing at least one hydroxyl or amino group. These polyethers include a fraction of 30% to 100% by weight of units derived from ethylene oxide.

Nonionically hydrophilicizing compounds also include, for example, monohydric polyalkylene oxide polyether alcohols containing on average 5 to 70, preferably 7 to 55, ethylene oxide units per molecule, such as are obtainable in conventional manner by alkoxylating appropriate starter molecules (e.g. in Ullmanns Encyclopädie der technischen Chemie, 4th edition, volume 19, Verlag Chemie, Weinheim pp. 31-38).

Examples of suitable starter molecules are saturated monoalcohols such as methanol, ethanol, n-propanol, isopropanol, n-butanol, isobutanol, sec-butanol, the isomers pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers, such as diethylene glycol monobutyl ether, unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol, secondary monoamines such as dimethylamine, diethylamine, dipropylamine, diisopropylamine, dibutylamine, bis(2-ethylhexyl)amine, N-methyl- and N-ethylcyclohexylamine or dicyclohexylamine and also heterocyclic secondary amines such as morpholine, pyrrolidine, piperidine or 1H-pyrazole. Preferred starter molecules are saturated monoalcohols. Particular preference is given to using diethylene glycol monobutyl ether as starter molecule.

Alkylene oxides suitable for the alkoxylation reaction are, in particular, ethylene oxide and propylene oxide, which may be used in any order or else as a mixture in the alkoxylation reaction.

The polyalkylene oxide polyether alcohols are either straight polyethylene oxide polyethers or mixed polyalkylene oxide polyethers at least 30 mol %, preferably at least 40 mol %, of whose alkylene oxide units are composed of ethylene oxide units. Preferred nonionic compounds are monofunctional mixed polyalkylene oxide polyethers containing at least 40 mol % ethylene oxide units and not more than 60 mol % propylene oxide units.

For the PUR polymers (I) it is preferred to use a combination of ionic and nonionic hydrophilicizing agents meeting the definitions of components I.5) and I.6). Particularly preferred combinations are those of nonionic and anionic hydrophilicizing agents.

Preference is given to using 5% to 45% by weight of component I.1), 50% to 90% by weight of component I.2), I.2) being composed of components I.2a) and I.2b), 1% to 30% by weight of the sum of compounds I.3) and I.4), not more than up to 12% by weight of component I.5), not more than up to 15% by weight of component I.6), the sum of I.5) and I.6) being 0.1% to 27% by weight and the sum of all of the components adding up to 100% by weight.

Particular preference is given to using 10% to 40% by weight of component I.1), 60% to 85% by weight of component I.2), I.2) being composed of components I.2a) and I.2b), 1% to 25% by weight of the sum of compounds I.3) and I.4), not more than up to 10% by weight of component I.5), not more than up to 10% by weight of component I.6), the sum of I.5) and I.6) being 0.1% to 20% by weight and the sum of all of the components adding up to 100% by weight.

Very particular preference is given to using 15% to 40% by weight of component I. 1), 60% to 82% by weight of component I.2), I.2) being composed of components I.2a) and I.2b), 1% to 20% by weight of the sum of compounds I.3) and I.4), not more than up to 8% by weight of component I.5), not more than up to 10% by weight of component I.6), the sum of I.5) and I.6) being 0.1% to 18% by weight and the sum of all of the components adding up to 100% by weight.

The coating compositions of the invention comprise PUR polymers (I) which are used in the form of their aqueous PUR dispersion (I).

The process for preparing the aqueous PUR dispersion (I) can be carried out in one or more stages in homogeneous phase or, in the case of multi-stage reaction, partly in disperse phase. Following partial or complete polyaddition of I.1)-I.6), a dispersing, emulsifying or dissolving step takes place. This is followed optionally by a further polyaddition or modification in disperse phase.

For the preparation of the aqueous PUR dispersions (I) it is possible to use all of the processes known from the prior art, such as prepolymer mixing processes, acetone processes or melt dispersing processes. The PUR dispersion (I) is preferably prepared by the acetone process.

For preparing the PUR dispersion (I) by the acetone process constituents I.2a) to I.6), which should not contain any primary or secondary amino groups, and polyisocyanate component I.1) are typically included wholly or partly in the initial charge for preparing an isocyanate-functional polyurethane prepolymer, and are diluted if desired with a solvent which is miscible with water but inert with respect to isocyanate groups, and the optionally diluted mixture is heated to temperatures in the range from 50 to 120° C. The isocyanate addition reaction can be accelerated using the catalysts known in polyurethane chemistry. Dibutyltin dilaurate is preferred.

Suitable solvents are the typical aliphatic, keto-functional solvents such as acetone, butanone, which can be added not only at the beginning of the preparation but also, if desired, in portions later on as well. Acetone and butanone are preferred.

Subsequently the constituents of I.1)-I.6) possibly not added at the beginning of the reaction are metered in.

In the preparation of the polyurethane prepolymer the molar ratio of isocyanate groups to isocyanate-reactive groups is 1.0 to 3.5, preferably 1.1 to 3.0, more preferably 1.1 to 2.5.

The reaction of components I. 1)-I.6) to form the prepolymer takes place partially or completely, but preferably completely. In this way polyurethane prepolymers are obtained which contain free isocyanate groups, in bulk (without solvent) or in solution.

The preparation of the polyurethane prepolymers is followed or accompanied, if it has not already been carried out in the starting molecules, by the complete or partial formation of salts of the anionically and/or cationically dispersing groups. In the case of anionic groups this is done using bases such as tertiary amines, examples being trialkylamines having 1 to 12, preferably 1 to 6, C atoms in each alkyl radical. Examples thereof are trimethylamine, triethylamine, methyldiethylamine, tripropylamine and diisopropylethylamine. The alkyl radicals may for example also carry hydroxyl groups, such as in the case of the dialkylmonoalkanolamines, alkyldialkanolamines and trialkanolamines. As neutralizing agents it is also possible optionally to use inorganic bases, such as ammonia or sodium hydroxide and/or potassium hydroxide. Preference is given to triethylamine, triethanolamine, dimethylethanolamine or diisopropylethylamine.

The molar amount of the bases is between 50% and 100%, preferably between 70% and 100%, by weight of the molar amount of the anionic groups. In the case of cationic groups use is made of dimethyl sulphate, phosphoric acid or succinic acid. Where only nonionically hydrophilicized compounds I.6) with ether groups are used, the neutralization step is omitted. Neutralization may also take place simultaneously with dispersing, with the dispersing water already containing the neutralizing agent.

Subsequently, in a further step of the process, if it has not already taken place or has taken place only partially, the resulting prepolymer is dissolved with the aid of aliphatic ketones such as acetone or butanone.

Thereafter, possible NH₂-functional and/or NH-functional components are reacted with the remaining isocyanate groups. This chain extension/termination may be carried out either in solvent prior to dispersing, in the course of dispersing, or in water after the dispersing. The chain extension is preferably carried out prior to dispersing in water.

Where chain extension is carried out using compounds meeting the definition of I.5) and containing NH₂ or NH groups, the prepolymers are preferably chain-extended prior to dispersing.

The degree of chain extension, in other words the equivalent ratio of NCO-reactive groups of the compounds used for chain extension to free NCO groups of the prepolymer, is between 40% to 150%, preferably between 70% to 120%, more preferably between 80% to 120%.

The aminic components [I.3), I.4), I.5)] can optionally be used in water- or solvent-diluted form in the process of the invention, individually or in mixtures, with any order of addition being possible in principle.

If water or organic solvents are concomitantly used as diluents then the diluent content is preferably 70% to 95% by weight.

The preparation of the PUR dispersion (I) from the prepolymers takes place following chain extension. For that purpose the dissolved and chain-extended polyurethane polymer is introduced into the dispersing water with strong shearing if appropriate, such as strong stirring, for example, or, conversely, the dispersing water is stirred into the prepolymer solutions. It is preferred to add the water to the dissolved prepolymer.

The solvent still present in the dispersions after the dispersing step is typically then removed by distillation. Removal even during dispersing is likewise possible.

Depending on the degree of neutralization and the amount of ionic groups it is possible to make the dispersion very fine, so that it almost has the appearance of a solution, although very coarse formulations are also possible, and are likewise sufficiently stable.

The solids content of the PUR dispersion (I) of the invention is between 20% to 70%, preferably 30% to 65% and more preferably between 35% to 62% by weight.

Crosslinkers II) used are blocked polyisocyanates, which where appropriate are in water-dispersible or water-soluble form or are used as an aqueous dispersion or solution.

In the sizes comprising the PUR polymer dispersions of the invention, the blocked polyisocyanates II) may be present in nonhydrophilicized form; for example, they may be added prior to the dispersing stage of the preparation of the polyurethane dispersions of the invention, so that the polyurethane dispersion has an emulsifying or dispersing effect on the blocked polyisocyanate.

The blocked polyisocyanates II) can be used likewise as an aqueous solution or dispersion. The solution or dispersion of the polyisocyanates II) has a solids content of between 10% to 70%, preferably from 20% to 60% and more preferably from 25% to 50% by weight and the solvent fraction of G) as a proportion of the overall composition is preferably less than 15% and more preferably less than 10% and very preferably less than 5% by weight. The blocked polyisocyanates II) have an (average) NCO functionality of 2.0 to 5.0, preferably of 2.3 to 4.5, an isocyanate group (blocked and non-blocked) content of 5.0% to 27.0% by weight, preferably of 14.0% to 24.0% by weight, and a monomeric diisocyanate content of less than 1% by weight, preferably less than 0.5% by weight. The isocyanate groups of the polyisocyanates A) of the water-dispersible and/or water-soluble blocked polyisocyanates II) are at least 50%, preferably at least 60% and more preferably at least 70% in blocked form.

The water-dispersible blocked polyisocyanates II) can be prepared by known methods of the prior art (e.g. in DE-A 2 456 469, column 7-8, Example 1-5 and DE-A 2 853 937 pp. 21-26, Example 1-9).

For preparing the aqueous solution or dispersion containing the water-dispersible blocked polyisocyanates II) the general approach is to use amounts of water such that the resulting dispersions or solutions, respectively, have a solids content of 10 to 70%, preferably 20% to 60% and more preferably 25% to 50% by weight.

Examples of component III) are polyester polymers, polyurethanes, acrylic polymers, vinyl polymers such as polyvinyl acetate, polyurethane dispersions, polyacrylate dispersions, polyurethane-polyacrylate hybrid dispersions, polyvinyl ether and/or polyvinyl ester dispersions, polystyrene dispersions and/or polyacrylonitrile dispersions.

As component IV) auxiliaries and additives are added to the size compositions. These may be coupling agents, lubricants, antistats or else the coatings additives well known per se to the skilled person, such as dyes, pigments, flow control assistants, light stabilizers, ageing inhibitors and UV absorbers.

As coupling agents it is possible to use the known silane coupling agents such as 3-aminopropyltrimethoxy- and/or -triethoxysilane, N-(2-aminoethyl)-3-amino-propyltrimethoxysilane, 3-glycidylpropyltrimethoxysilane, vinyltrimethoxysilane, vinyltriethoxysilane or 3-methacryloyloxypropyltriethoxysilane. The concentration of the silane coupling agents in the size compositions of the invention is preferably 0.05% to 2% by weight, more preferably 0.15% to 0.85% by weight, based on the size composition as a whole.

Likewise provided by the present invention is a process for preparing the size compositions of the invention, characterized in that a mixing vessel is charged with water and, with stirring, the binder (I), the curing agent (II) and subsequently the lubricant (IV) and optionally further auxiliaries from component (IV) are added, after which the pH (20° C.) is adjusted to 5 to 7 and a hydrolysate of a coupling agent from component (IV) is added.

The size compositions comprising the PUR polymer dispersions of the invention may further comprise one or more nonionic and/or ionic lubricants as part of component IV), such as polyalkylene glycol ethers of fatty alcohols or fatty amines, polyalkylene glycol ethers and glyceryl esters of fatty acids having 12 to 18 carbon atoms, polyalkylene glycols, higher fatty acid amides having 12 to 18 carbon atoms of polyalkylene glycols and/or alkyleneamines, quaternary nitrogen compounds, e.g. ethoxylated imidazolinium salts, mineral oils and waxes. The lubricants are employed preferably in a total concentration of 0.05% and 1.5% by weight, based on the size composition as a whole.

The size compositions may also comprise one or more antistats. Examples that may be mentioned include lithium chloride, ammonium chloride, Cr(III) salts, organotitanium compounds, arylalkyl sulphates or arylalkylsulphonates, aryl polyglycol ether sulphonates or quaternary nitrogen compounds. The antistats are used preferably in concentrations of 0.01% to 0.8% by weight.

The size compositions may be prepared by the methods known per se. Preferably, water is charged to a suitable mixing vessel and, with stirring, the binder, the curing agent and then the lubricant and any further auxiliaries from component IV) are added. Thereafter the pH is adjusted to 5-7 and a hydrolysate of a coupling agent from component IV) is added. After a further stirring time of 15 minutes the size composition is ready to be used and can be applied following pH adjustment where appropriate.

The size compositions can be applied to a suitable substrate by any desired methods, such as by means of spray applicators or roll applicators, for example, and cured. Suitable substrates are glass fibres or carbon fibres.

The present invention also provides glass fibres or carbon fibres coated with a size composition comprising the aqueous PUR polymer dispersions of the invention.

Glass types suitable for the sized glass fibres include not only the known glass types used for fibreglass manufacture, such as E, A, C and S glass in accordance with DIN 1259-1, but also the other, conventional products of the glass fibre producers. Among the types of glass mentioned, the E glass fibres possess the greatest importance for the production of continuous glass fibres, for the reinforcement of plastics, owing to their freedom from alkali, their high tensile strength and their high modulus of elasticity.

The process of producing, the process of sizing and the subsequent processing of the glass fibres is known and is described for example in K. L. Loewenstein “The Manufacturing Technology of Continous Glass Fibres”, Elsevier Scientific Publishing Corp., Amsterdam, London, New York, 1983.

### EXAMPLES

Unless indicated otherwise all percentages are to be understood as weight percentages.

Substances and Abbreviations Used:

Diaminosulphonate: NH₂—CH₂CH₂—NH—CH₂CH₂—SO₃Na (45% strength in water)
Desmophen® 2020: polycarbonate polyol, OH number 56 mg KOH/g, number-average molecular weight 2000 g/mol (Bayer AG, Leverkusen, Del.)
PolyTHF® 2000: polytetramethylene glycol polyol, OH number 56 mg KOH/g, number-average molecular weight 2000 g/mol (BASF AG, Ludwigshafen, De)
PolyTHF® 1000: polytetramethylene glycol polyol, OH number 112 mg KOH/g, number-average number-average molecular weight 1000 g/mol (BASF AG, Ludwigshafen, Del.)
Polyether LB 25: monofunctional polyether based on ethylene oxide/propylene oxide, number-average molecular weight 2250 g/mol, OH number 25 mg KOH/g (Bayer AG, Leverkusen, Del.)
KV 1386 hydrophilicizing agent (BASF AG, Ludwigshafen, Del.)
Breox® 50-A 140 lubricant (BP Chemicals, GB)

The solids contents were determined in accordance with DIN-EN ISO 3251.

Unless expressly mentioned otherwise, NCO contents were determined volumetrically in accordance with DIN-EN ISO 11909.

Crosslinker Dispersion (Component II):

147.4 g of a polyisocyanate containing biuret groups, based on 1,6-diisocyanatohexane (HDI) and having an NCO content of 23.0% were stirred with 39.2 g of Polyether LB 25 at 100° C. for 30 minutes. Subsequently, over the course of 20 minutes, 493.0 g of caprolactam were added with stirring at a rate such that the temperature of the mixture did not exceed 110° C. The mixture was stirred at 110° C. until the theoretical NCO value was reached. Thereafter it was cooled to 90° C. and over the course of 2 minutes a mixture of 152.5 of the hydrophilicizing agent KV 1386 and 235.0 g of water was metered in. That was followed by dispersing, by the addition of 3325.1 g of water. Subsequent stirring for a time of 2 h gave a storage-stable aqueous dispersion having a solids content of 30.0%.

Preparation of Polyamide Polyol

### Example 1

### Polyamide Polyol

A 21 reaction vessel with stirring apparatus, heating and reflux condenser is charged under nitrogen with 748 g of isophoronediamine IPDA (8.8 equivalents of amino groups) and this initial charge is heated to 80° C. with stirring. Then 1003.2 g of caprolactone (8.8 equivalents) are metered in over 20 minutes and the temperature is raised to 120° C. After 3 hours at 120° C. the batch is cooled and the clear, viscous product is discharged.

### Example 2

### Comparative Example PUR Dispersion (Component I)

1530.0 g of a difunctional polyester polyol based on adipic acid and hexanediol (average molecular weight 1700 g/mol, OHN=about 66 mg KOH/g substance) and 67.50 g of Polyether LB 25 were heated to 65° C. Subsequently at 65° C., over the course of 5 minutes, 455.1 g of isophorone diisocyanate were added and the mixture was stirred at 100° C. until the theoretical NCO value of 4.6% was reached. The finished prepolymer was dissolved with 2781 g of acetone at 50° C. and then a solution of 139.1 g of isophoronediamine and 247.2 g of acetone was metered in over the course of 10 minutes. Subsequently a solution of 46.0 g of diaminosulphonate, 4.80 of hydrazine hydrate and 239.1 g of water was metered in over the course of 5 minutes. The subsequent stirring time was 15 minutes. This was followed by dispersing over the course of 10 minutes, by addition of 3057 g of water. The removal of the solvent by vacuum distillation followed that, to give a storage-stable PUR dispersion having a solids content of 40.1% and a particle size of 207 nm.

### Example 3

### PUR Dispersion (Component I, Inventive)

252.0 g of a difunctional polyester polyol based on adipic acid and hexanediol (average molecular weight 1700 g/mol, OHN=about 66 mg KOH/g substance) and 11.3 g of Polyether LB 25 and 19.7 g of a polyamide polyol as per Example 1 were heated to 65° C. Subsequently at 65° C., over the course of 5 minutes, 49.7 g of isophorone diisocyanate and 37.6 g of hexamethylene diisocyanate were added and the mixture was stirred at 100° C. until the theoretical NCO value of 5.6% was reached. The prepolymer was dissolved with 658.2 g of acetone at 50° C. and then a solution of 29.2 g of isophoronediamine and 51.9 g of acetone was metered in over the course of 10 minutes. Subsequently a solution of 9.7 g of diaminosulphonate, 1.0 g of hydrazine hydrate and 50.6 g of water was metered in over the course of 5 minutes. The subsequent stirring time was 15 minutes. This was followed by dispersing over the course of 10 minutes, by addition of 550.4 g of water. The removal of the solvent by vacuum distillation followed that, to give a storage-stable PUR dispersion having a solids content of 40.2% and a particle size of 172 nm.

### Application Examples

The compositions were prepared as follows:

A mixing vessel was charged with half the indicated amount of water and, in succession and with stirring, the inventive PUR dispersions, film-forming resins, crosslinker dispersion and lubricant (Breox® 50-A 140, BP Chemicals, GB) were added. Thereafter the pH was adjusted with acetic acid to 5-7 and a hydrolysate, prepared according to the manufacturer's instructions, of 3-aminopropyltriethoxysilane (A 1100, UCC, New York, USA) was added as an aqueous coupling agent solution. After a further stirring time of 15 minutes the size was ready to use.

Subsequently, following adjustment of the pH to 5-7 where appropriate, the size compositions were applied to glass fibres. The glass fibres thus sized were subsequently chopped and dried and compounded into polyamide 6 or polyamide 6,6 (GF fraction=30%).

Table 1 shows the size compositions in detail:

| | Size 1 | Size 2 |
|---|---|---|
| | Comparative | Inventive |
| Water | 42.0 kg | 42.0 kg |
| PUR dispersion | 12.0 kg | 12.0 kg |
| | Example 2 | Example 3 |
| Crosslinker dispersion | 8.0 kg | 8.0 kg |
| Coupling agent | 0.6 kg | 0.6 kg |
| Lubricant | 0.4 kg | 0.4 kg |
| Water | 37.0 kg | 37.0 kg |
| Total | 100.0 kg | 100.0 kg |
| Polyamide 6,6 | | |
| Tensile strength [MPa] | 191 | 192 |
| Impact strength ISO 179 1eU | 75 | 87 |
| [kJ/m²] | | |
| Impact strength ISO 180 1A | 10 | 11 |
| [kJ/m²] | | |
| Polyamide 6 | | |
| Tensile strength [MPa] | 179 | 181 |
| Impact strength ISO 179 1eU | 71 | 82 |
| [kJ/m²] | | |
| Impact strength ISO 180 1A | 10 | 12 |
| [kJ/m²] | | |

The impact strengths found both in polyamide 6 and in polyamide 6,6 demonstrate the significant improvements with the sizes of the invention.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Aqueous polyurethane-polyurea polymer dispersions (PUR polymers) comprising structural units of formula (I) 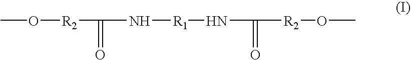
in which
R1 is an aliphatic or cycloaliphatic radical having 2 to 18 C atoms and
R2 is an aliphatic radical having 3 to 5 C atoms.

2. Aqueous polyurethane-polyurea polymer dispersions according to claim 1, wherein the PUR polymer contains at least 0.5% by weight of amide groups, calculated as (CO)NH.

3. Aqueous polyurethane-polyurea polymer dispersions according to claim 1, wherein the polyurethane-polyurea polymers (PUR polymers) comprise the reaction products of:
I.1) one or more polyisocyanates,
I.2a) one or more polymeric polyols having number-average molecular weights of 200 to 8000 g/mol,
I.2b) one or more polyamide polyols of the general formula (II)
in which 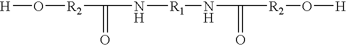
R₁ is an aliphatic or cycloaliphatic radical having 2 to 18 C atoms and
R₂ is an aliphatic radical having 3 to 5 C atoms,
I.3) one or more low molecular weight compounds of molar weight 62 to 400, possessing in total two or more hydroxyl and/or amino groups,
I.4) optionally, one or more compounds which possess a hydroxyl or amino group,
I.5) and one or more compounds selected from the groups consisting of isocyanate-reactive, ionically or potentially ionically hydrophilicizing compounds and/or
I.6) isocyanate-reactive, nonionically hydrophilicizing compounds.

4. Aqueous polyurethane-polyurea polymer dispersions according to claim 1, wherein component I.2a) are polyester polyols.

5. Aqueous polyurethane-polyurea polymer dispersions according to claim 1, wherein component I.2b) is synthesized from diamines containing a primary and a secondary amino group, and ε-caprolactone.

6. Aqueous polyurethane-polyurea polymer dispersions according to claim 1, wherein component I.2b) is synthesized from reaction products of compounds selected from the group of 1,6-hexamethylenediamine, 2-methyl-1,5-diaminopentane, 1-amino-3,3,5-trimethyl-5-aminomethylcyclohexane (isophoronediamine), the isomers of bis(4-aminocyclohexyl)methane, and mixtures thereof, with ε-caprolactone.

7. Aqueous polyurethane-polyurea polymer dispersions according to claim 1, wherein a combination of ionic and nonionic hydrophilicizing agents meeting the definitions of components I.5) and I.6) are used.

8. Size compositions comprising (I) aqueous PUR polymer dispersions according to claim 1 and
(II) hydrophilicized, blocked polyisocyanates, at least 50% of whose isocyanate groups are blocked,
(III) optionally further polymers soluble, emulsifiable or dispersible in water, and
(IV) auxiliaries and additives selected from the group of coupling agents, lubricants, antistats, dyes, pigments, flow control agents, light stabilizers, ageing inhibitors or UV absorbers.

9. Process for preparing the size compositions according to claim 8, the process comprising the steps of:
1) charging a mixing vessel with water,
2) with stirring, adding the binder (I), the curing agent (II) and subsequently the lubricant (IV) and optionally further auxiliaries from component (IV), and
3) adjusting the pH (20° C.) to between 5 to 7 and
4) adding a hydrolysate of a coupling agent from component (IV).

10. Glass fibre coated with size composition according to claim 8.

11. Carbon fibre coated with size composition according to claim 8.
